(19) United States
(12) Patent Application Publication
(10) Pub. No.: US 2009/0136781 A1
(43) Pub. Date: May 28, 2009

(54) Method For The Generation Of A Functional Layer

(76) Inventors: Rajiv J. Damani, Winterthur (CH); Arno Refke, Fahrwangen (CH); Konstantin Von Niessen, Buttwil (CH)

Correspondence Address: ROBERT S. GREEN, SULZER METCO (US), INC., 1101 PROSPECT AVENUE, WESTBURY, NY, 11590, US

(21) Appl. No.: 12/191,864

(22) Filed: Aug. 14, 2008

(30) Foreign Application Priority Data
Aug. 16, 2007 (EP) 07114429.0

(51) Int. Cl. B32B 9/00; B05D 3/06

(52) U.S. Cl. 428/702; 427/576; 427/559

(57) ABSTRACT

A method for the generation of a functional layer is proposed in which a coating material is sprayed onto a surface of a substrate in the form of a jet of powder by means of a plasma spraying process, wherein the coating material is injected at a low process pressure which is less than 10 000 Pa into a plasma, which defocuses the jet of powder and is melted partly or completely there, wherein a plasma with adequately high specific enthalpy is produced, so that a substantial proportion, amounting to at least 5% by weight of the coating material passes over into the vapour phase and an anisotropically structured layer arises on the substrate, wherein elongate corpuscles, which form an anisotropic microstructure, are aligned standing largely perpendicular to the surface of the substrate and transition regions with little material delimit the corpuscles with respect to one another. In a second step capillary spaces of the layer are filled to strengthen the layer, with a liquid being used as a reinforcing medium, which includes at least one salt of a metal contained therein, which can be thermally converted into a metal oxide, with the reinforcing medium being applied to the surface of the layer and—after waiting for a penetration into the capillary spaces—an introduction of heat takes place for the formation of an oxide.

### CROSS-REFERENCE TO RELATED APPLICATIONS

The present application claims priority under 35 U.S.C. §119 of European Patent Application No. 07114429.0 filed on Aug. 16, 2007, the disclosure of which is expressly incorporated by reference herein in its entirety.

### STATEMENT REGARDING FEDERALLY SPONSORED RESEARCH OR DEVELOPMENT

Not applicable.

### REFERENCE TO A COMPACT DISK APPENDIX

Not applicable

### BACKGROUND OF THE INVENTION

The invention relates to a method for the generation of a functional layer and to a component with such a layer in accordance with the pre-characterising part of the independent claim in the respective category.

The method in accordance with the invention includes as a first step a plasma spraying process of the generic kind, which is described in WO-A-03/087422 or also in U.S. Pat. No. 5,853,815. This plasma spraying process is a thermal spraying process for the generation of a so-called LPPS thin film (LPPS=low pressure plasma spraying). The invention relates to a further development of the method and to components which are coated according to the method in accordance with the invention.

Using the LPPS thin film process (LPPS-TF=LPPS thin film) a conventional LPPS plasma spraying method is modified method-wise, with a space through which plasma flows (“plasma flame” or “jet of plasma”) being enlarged due to the modification and is extended to a length of up to 2.5 m. The geometric extent of the plasma leads to a uniform enlargement—a “defocusing”—of a jet of powder, which is injected into the plasma with a feed gas. The material of the jet of powder, which disperses in the plasma to a cloud and is melted completely or partly there, passes uniformly distributed onto a widely expanded surface of a substrate. A thin layer is generated on the substrate, the layer thickness of which can be smaller than 10 μm and which, thanks to the uniform distribution, forms a dense covering. A thicker coating with special characteristics can be generated by means of the multiple application of thin layers, which makes such a coating usable as a functional layer. A porous coating can, for example, be generated with a multiple application and is suitable as a carrier for catalytically active materials (see EP-A-1 034 843=P.6947).

A functional layer, which is applied to a base body forming the substrate, includes different part layers as a rule. For example, the blades for a gas turbine (stationary gas turbine or aircraft engine), which is driven at high process temperatures, are coated with a first single or multiple-layered part layer, which manufactures a resistance to hot gas corrosion. A second coating, which is applied to the first part layer and which is used for the ceramic material, forms a heat insulating layer. The LPPS plasma spraying process is suitable for the generation of the first layer. The heat insulating layer is preferably produced using a method in which a coating is generated with a columnar microstructure. The so structured layer is composed approximately from cylindrical small bodies or corpuscles, the central axes of which are aligned perpendicular to the surface of the substrate. Transition regions in which the density of the deposited material is smaller than in the corpuscles, bound the corpuscles laterally/sideways. A coating of such a kind, which has an anisotropic micro-structure, is more resilient to alternating stresses, which result from repeatedly occurring changes in temperature. The coating reacts to the alternating stress in a largely reversible manner, i.e. without a formation of cracks or a flaking off of material, so that its working life is considerably lengthened in comparison with the working life of a usual coating, which does not have a columnar micro-structure.

The anisotropic micro-structure can be produced using a thin film method, which is a vapour deposition method. In this method, which is termed “EB-PVD” (electron beam—physical vapour deposition), the substance to be deposited for the heat insulating layer is brought into the vapour phase in a high vacuum with an electron beam and from this is condensed onto the component to be coated. If the process parameters are suitably selected, then a columnar micro-structure results. One disadvantage of this vapour deposition method is the high plant costs. Furthermore, in the generation of a coating including multiple part layers, the same plant can not be used for the LPPS plasma spraying process and for the EB-PVD process. For this reason a plurality of working cycles have to be carried out for the coating.

It is known from the already mentioned WO-A-03/087422 that such anisotropic micro-structures with elongate corpuscles, which are aligned standing substantially perpendicular to the surface of the substrate and are delimited with respect to one another by transition regions with little material, and which thus have a columnar structure, can also be manufactured by means of the LPPS-TF method.

Heat insulating layers with a columnar microstructure are also used in aircraft engines in particular, for example as a heat protection layer on the turbine blades of the guide vanes and of the rotor blades, and are often exposed to extreme operating conditions there. In addition to the high thermal stresses it has been shown that erosion also leads to a degradation of these heat protection layers. Considerable signs of wear, which are due to erosion, are observed when these are used in desert regions for example, where the air features a high proportion of sand particles.

### BRIEF SUMMARY OF THE INVENTION

It is therefore the object of the invention to propose a method for the generation of a functional layer, with which a heat insulating layer can be generated, which has an anisotropic columnar microstructure and which shows an increased resistance to erosion. A component with such a layer is to be proposed further by the invention.

The subjects of the invention satisfying this object are characterised by the independent claims in the respective category.

In accordance with the invention a method is thus proposed for the manufacture of a functional layer in which, in a first step, a coating material is sprayed onto a surface of a substrate in the form of a jet of powder by means of a plasma spraying process, wherein the coating material is injected at a low process pressure which is less than 10 000 Pa into a plasma which defocuses the jet of powder and is melted partly or completely there, wherein a plasma with adequately high specific enthalpy is produced, so that a substantial proportion, amounting to at least 5% by weight of the coating material passes over into the vapour phase and an anisotropically structured layer arises on the substrate, wherein elongate corpuscles, which form an anisotropic microstructure, are aligned standing largely perpendicular to the surface of the substrate and transition regions with little material delimit the corpuscles with respect to one another. In a second step capillary spaces of the layer are filled to strengthen the layer, with a liquid being used as a reinforcing medium, which includes at least one salt of a metal (Me) contained therein, which can be thermally converted into a metal oxide, with the reinforcing medium being applied to the surface of the layer and—after waiting for a penetration into the capillary spaces—an introduction of heat takes place for the formation of an oxide.

Thus, in a first step, an anisotropically structured columnar layer is initially generated on the substrate by means of a LPPS-TF (low pressure plasma spraying thin film), which is then subsequently reinforced or impregnated in a second step, by applying a liquid with a metal salt to the surface and by an oxide then being formed by the introduction of heat. It has been shown, surprisingly, that the resistance to erosion of the layer improves considerably through the second method step, namely, the reinforcement of the LPPS-TF layer. Comparative experiments have, for example, shown that a seven times better resistance to erosion can be achieved by the reinforcement i.e. the impregnation.

It has proved particular advantageous when the second step, namely the application of the reinforcing medium and the introduction of heat for the formation of the oxide is carried out several times, in particular three times.

From a practical point of view it is preferred when the reinforcing medium is an aqueous solution, which contains a salt of the oxidisable metal (Me) in solution, and the metal salt is preferably a nitrate or acetate of the metals Co, Mn. Mg, Ca, Sr, Y, Zr, Al, Ti, Ni, La, Sc and/or of a lanthanide, in particular of one of the lanthanides Ce; Eu, Yb, Nd, Dy or Gd. The metal is preferably one which is also contained in the plasma sprayed layer in ceramic or oxidic form. It can also be advantageous if the oxidised metal is insoluble in water.

The reinforcing medium can, naturally, also contain the salts of a plurality of oxidisable metals. The choice of the reinforcing medium or its composition depends on the coating material used for the plasma spraying.

The heat feed for the heat introduction for the formation of the oxide preferably takes place in a thermal oven, in a microwave oven, with a heat radiator, in particular a carbon radiator with a wavelength range of 2 μm-3.5 μm and/or with a flame.

Depending on the actual case it can be advantageous that the heat feed is carried out in an inert atmosphere or in the vacuum. In principle any protective gas known per se, for example argon, can be used for the realisation of an inert atmosphere.

In an embodiment particularly relevant in practice the anisotropically structured layer is a heat insulating layer, which is used in a gas turbine for example and the layer thickness of which have values between 20 μm and 2000 μm, preferably values of 100 μm to 500 μm.

Practical experience has shown that it is particular advantageous when in the plasma spraying process:

a value between 20 and 2000 Pa, preferably between 100 and 500 Pa is selected for the process pressure and the specific enthalpy of the plasma is produced by means of an effective power, which lies in the range of 40 to 80 kW in particular, the jet of powder is injected into the plasma with a feed gas, the process gas is a mixture of inert gases, in particular a mixture of argon Ar and helium He, wherein the volume ratio of Ar to He advantageously lies in the range from 2:1 to 1:4, and the total gas flow lies in the range from 30 to 150 SLPM, wherein the mixture can optionally additionally contain hydrogen H or nitrogen N

the powder feed rate lies between 2 and 80 g/min, preferably between 10 and 40 g/min, and

during the application of material the substrate is preferably moved with rotary or pivoting movements relative to a cloud of the defocused jet of powder.

In particular for the production of heat insulating layers a material is preferably used for the coating, which contains oxide-ceramic components, wherein such a component is in particular a zirconium oxide stabilised with magnesium, calcium, scandium, yttrium, cerium, dysprosium, or other rare earths and the material used as a stabiliser is added to the zirconium oxide in the form of an oxide of the said rare earths or of the said magnesium or of the said calcium. This addition can in particular also take place by means of alloying.

Depending on the actual case it can be advantageous when, after the single or multiple carrying out of the second step, a heat treatment for the sintering takes place which is preferably done at least 800° C. It had been shown that such a treatment should take place over a sufficiently long period of time of at least 10 hours for example, at 800° C. at the least, in particular at 1000° C. to 1200° C., in order to achieve as good a resistance to erosion as possible. It is, however, also possible that this heat treatment for sintering is not carried out as a separate step, but is realised after the starting up of the component in normal operation by the operating temperature.

The method is particularly suitable for the coating, especially the heat protective coating, of components in turbines, stationary gas turbines or aircraft engines, when the substrate is a component of a stationary gas turbine or of an aircraft engine namely, a turbine blade (52), in particular a guide vane or a rotor blade, or a segment which includes at least two turbine blades or a component which can be exposed to a hot gas, for example a heat shield.

The method in accordance with the invention has a further advantage in comparison with the known method, with which a columnar structured layer is generated by means of EB-PVD: the process times for layers of the same thickness are considerably shorter.

Further advantageous measures and preferred embodiments of the invention result from the dependent claims.

### BRIEF DESCRIPTION OF THE DRAWINGS

The invention will be explained in more detail in the following with the help of embodiments and with the help of the drawings. The schematic drawings show, partly in section:

FIG. 1 an anisotropically structured layer, generated according to an embodiment of the method in accordance with the invention in a schematic illustration,

FIG. 2 a schematic illustration of a layer system with a heat insulating layer, which is generated according to an embodiment of the method in accordance with the invention,

FIG. 3 a segment of a turbine with two turbine blades,

FIG. 4 a section through the segment in FIG. 3 parallel to the base plate, and

FIG. 5 a schematic illustration of two elongate corpuscles of the anisotropic microstructure.

### DETAILED DESCRIPTION OF THE INVENTION

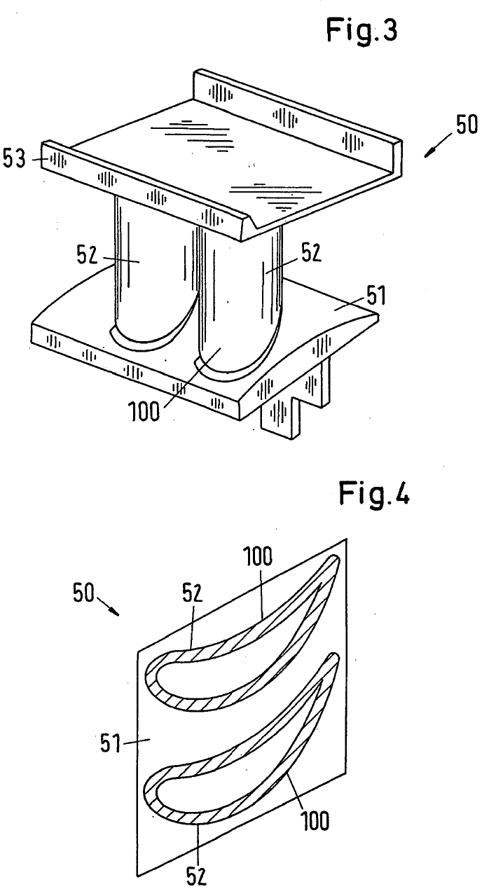

Reference will be made in the following to an example of use which is particularly relevant for practical use that a heat insulating layer with a columnar structure is provided as a functional layer on a turbine blade used in the high temperature range or on a segment, which includes a plurality of turbine blades (see FIG. 3 and FIG. 4). Such heat insulating layers are also termed TBC layers (TBC=thermal barrier coating).

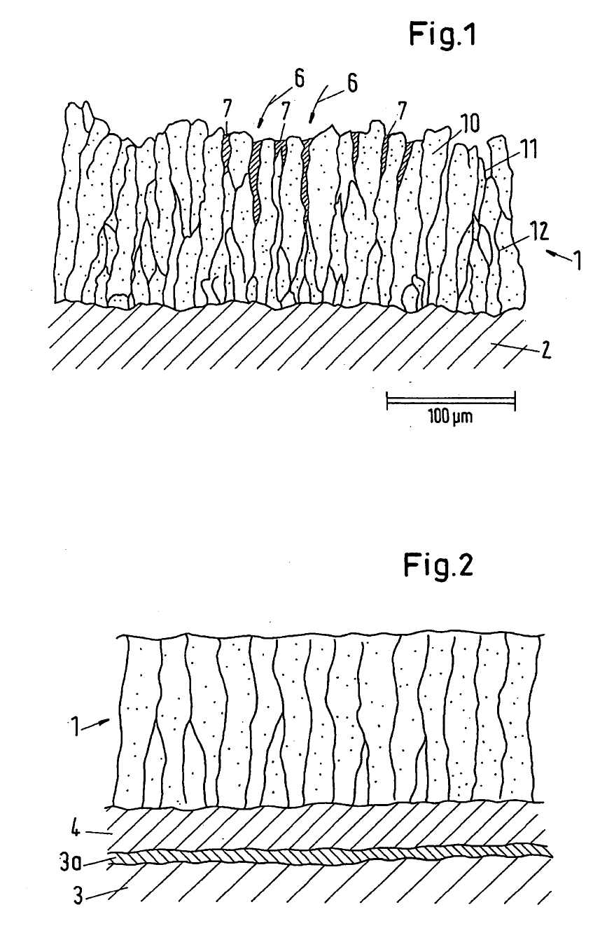

The method in accordance with the invention for the generation of a functional layer 1 (FIG. 1) includes two steps: in a first step an anisotropically structured layer is initially generated on a substrate 2 by means of a plasma spraying process, which is a LPPS process, in a second step this layer 1 is subsequently reinforced.

In FIG. 1 a section through a layer 1 generated according to an embodiment of the method in accordance with the invention is illustrated. The layer 1 deposited in a first step on a substrate, using the LPPS-TF process is anisotropically structured and has a layer thickness of approximately 150 μm. The anisotropic microstructure is formed by elongate corpuscles 10, which stand largely perpendicular to the surface of the substrate. Transition regions 12 with little material, which are drawn as lines, and slit-shaped intermediate spaces 11 delimit the corpuscles 10. The transition regions 12 and the slit-shaped intermediate spaces 11 are subsumed under the term capillary spaces. The capillary spaces can be further formed as pores and cracks. A reinforcement of the layer 1 takes place by means of the second method step, in which a reinforcing medium—indicated by the arrows provided with the reference numeral 6 in FIG. 1—is applied onto the layer 1, penetrates into the capillary spaces 11, 12 and is subsequently transformed into a metal oxide 7 by the introduction of heat. The illustration of the metal oxide 7 incorporated in the capillary spaces 11, 12 in FIG. 1 is very schematic.

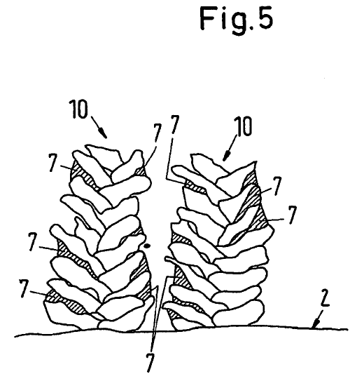

FIG. 5 shows, for better understanding, in a schematic illustration two elongate corpuscles 10 of the anisotropic microstructure. The individual elongate corpuscles 10 bring to mind feathers as regards their structure, because they display fringed boundary regions. These pores or intermediate spaces in the boundary regions of the individual corpuscles 10 are meant by the term “capillary spaces” i.e. are included by this term. In the second step of the method in accordance with the invention the reinforcing medium also penetrates into these capillary spaces in the boundary region of the individual corpuscles 10, so that with the introduction of heat formation of the oxide also results there, as is very schematically illustrated in FIG. 5 by the shaded areas 7.

Naturally, the reinforcing medium, i.e. the oxide, is also present between the two corpuscles 10 in FIG. 5. An illustration of this was dispensed with here however for better clarity. Moreover, in FIG. 5, the spacing of the individual corpuscles 10 is shown in an exaggerated manner. The corpuscles 10 are usually closer together. They can be intermeshed with one another across their individual boundary regions, such as would be the case with bird feathers arranged standing close next to each other.

Now the first method step namely, the production of the heat insulating layer will first be explained in more detail.

In this example zirconium oxide, which is stabilised with yttrium Y namely, ZrO₂-8% Y₂O₃ is used as a coating material. The substrate 2 can either be a bond promotion layer or a protective layer against corrosion or however, also a base body.

In order that the anisotropic microstructure develops, a plasma with a sufficiently high specific enthalpy has to be produced, so that a substantial proportion of the coating material, at least 5% by weight, passes over into the vapour phase. The proportion of the vaporised material, which is not allowed to pass over entirely into the vapour phase, can amount to up to 70%. The plasma is produced in a torch with an electrical direct current and by means of a pin cathode and a ring-shaped anode. The power supplied to the plasma, the effective energy, can be determined or adjusted relative to the resulting layer structure. Experience has shown that the effective power, which is given by the difference between the electrical power and the heat removed by cooling, lies in the range of 40 to 80 kW.

A value between 20 Pa and 2000 Pa is selected for the process pressure of the LPPS-TF plasma spraying process, preferably between 100 Pa and 500 Pa. A jet of powder is injected into the plasma with a feed gas. The process gas for the production of the plasma is a mixture of inert gases, in particular a mixture of argon Ar and helium He, with the volume ratio of Ar to He advantageously lying in the range from 2:1 to 1:4. The total gas flow lies in the range from 30 to 150 SLPM (standard litre per minute). As an option hydrogen and/or nitrogen can additionally be added to the mixture, for example to realise a higher electrical power in the plasma. The powder feed rate lies between 2 and 80 g/min, preferably between 10 and 40 g/min. The jet of powder is converted to a cloud of vapour and particles in the defocusing plasma. During the application of the material the substrate is moved with rotary or swinging movements relative to this cloud. It is naturally also possible to move the plasma torch relative to the substrate 2. In this connection the heat insulating layer is built up by the deposition of a plurality of layers. The total layer thickness has values between 2 and 2000 μm, preferably values of 100 μm to 500 μm.

An oxide ceramic material or a material, which contains oxide ceramic components is suitable for the generation of a heat insulating layer according to the LPPS-TF process, with the oxide ceramic material being, in particular, a zirconium oxide stabilised with rare earths or with magnesium or with calcium. The material used as a stabiliser is added to the zirconium oxide in the form of an oxide of the rare earths, for example yttrium Y, cerium Ce, dysprosium Dy or scandium Sc, or of magnesium or of calcium, with the oxide forming a proportion of 5 to 20% by weight for the example of Y.

In order that the jet of powder is converted into a cloud of vapour and particles by the defocusing plasma, out of which a layer 1 with the desired microstructure results, the powdery starting material has to be fine grained. The size distribution of the powder particles is determined by means of a laser scattering method. For this size distribution it must be the case that it lies to a substantial extent in the range between 1 and 50 μm, preferably between 3 and 25 μm. Different methods can be used for the manufacture of the powder particles: for example spray drying or a combination of melting and subsequent crushing and/or milling of the rigid melt.

In the layer illustrated in FIG. 1, which shows a good columnar microstructure, the following values have been used for the process parameters: process pressure=150 Pa; process gas: Ar, 35 SLPM, and He, 60 SLPM; powder feed rate=20 g/min; spraying distance=900 mm.

With an increase of the feed rate to 40-50 g/min for example, and without the other parameters being altered, one obtains a less columnar structured layer. The microstructure may still be of columnar structure but it is no longer very suitable for use as a heat insulating layer with a high degree of resistance to alternating thermal loading.

An even greater increase of the feed rate to values greater than 60 g/min brings about a complete disappearance of the columnar microstructure. An increase of the process pressure or of the gas flow also leads to a disappearance of the columnar microstructure. Interestingly, a profiled surface with strongly pronounced raised portions occurs with these having formed over the raised portions of the substrate 2. In the layer 1 in FIG. 1 one also recognises that a similar relationship exists between the anisotropic microstructure and the surface profile of the substrate 2. The elongate corpuscles 10 preferably start from elevations of the substrate 2.

The reinforcement of the layer 1 takes place in the second method step. In this respect capillary spaces 11, 12 of the layer 1 are, in each case, at least partly filled by one application, whereby the intended function of the overall layer 1 and in particular the erosion resistance of the heat insulation layer is quite decisively improved. In this connection a liquid is used as a reinforcing medium 6, which comprises a solvent and at least one salt of a metal contained therein, which can be thermally converted into a metal oxide. The reinforcing medium 6 is applied to the surface of the layer. Further—after waiting for a penetration into the capillary spaces 11, 12—the solvent is vaporised with the feed of heat at an increasing temperature and the formation of an oxide occurs, for example in that the metal is transformed into the metal oxide 7 at an elevated temperature.

The selection of the suitable metal in the reinforcing medium 6 depends on the coating material used in the first method step for the LPPS-TF layer. For example one of the following ceramic materials or a mixture of these materials can be used for such LPPS-TF layers; namely oxides of the metals Me=Zr, Ce, Y, Al or Ca. As reinforcing mediums 6—corresponding to the metals Me—aqueous solutions of the nitrates Me(NO₃)ₓ can be used, with x=2 for Ca and x=3 for Zr, Ce, Y or Al. The metal nitrates are, as a rule, obtainable as crystalline hydrates, for example Ce(NO₃)₃₋₆H₂O, which is readily soluble in water. Heavy metal nitrates decompose at elevated temperatures into the corresponding oxides (for example Ce₂O₃) with the simultaneous formation of gaseous NO₂. The conversion temperature, at which the oxide formation takes place, lies between approximately 200° C. to 350° C. With an increase in temperature the treatment time is reduced (for example 15 min at 350° C., 10 min at 400° C.). Metal salts of Co, Mn, Mg, Sr, Ti, Ni, La, Sc and/or of a lanthanide, in particular Ce, Eu, Gd, Yb, Nd, Dy are further suitable for the reinforcing medium.

In the example described here (FIG. 1), the layer is generated from a powder-like, ceramic material—namely, YSZ, i.e. zirconium oxide ZrO₂ stabilised with yttrium Y as a heat insulating layer with a columnar structure, as already mentioned. In concrete terms this is ZrO₂-8% Y₂O₃, which has been formed to a TBC layer with columnar structure by means of LPPS-TF. With this coating material an aqueous solution can be selected as a suitable reinforcing medium, which contains both a zirconium salt and also an yttrium salt, for example the respective nitrates. In this arrangement the zirconium salt content and the yttrium salt content are selected in such a way that in the oxidisation zirconium oxide with 8% (by weight) yttrium oxide occurs, in other words essentially the same composition, which is also used as coating material. In this arrangement yttrium is present in a solid solution in the zirconium oxide, which is form as a tetragonal phase or, if necessary, also as a cubic phase.

A liquid is thus used as a reinforcing medium, which includes a solvent and at least one metal Me, contained therein, which can be thermally converted into a metal oxide. The metals Me are, for example, present in the form of cations, the corresponding anions are inorganic compounds, for example nitrate, NO³⁻, or inorganic compounds, for example alcoholates and acetates. If alcoholates are used, then chelate ligands, such as, for example, acetylacetonate are advantageously added, which considerably reduces the sensitivity to hydrolysis of the alcoholates with respect to air humidity. In this way a flocculation of the oxides in the reinforcement process is prevented. The reinforcing medium 6 is applied to the surface of the layer 1. As a result of capillary forces, it penetrates the capillary spaces 11, 12: after waiting for the penetration of the reinforcing medium 6 into the capillary spaces 11, 12 an introduction of heat takes place. With a feed of heat at an increasing temperature, the solvent of the reinforcing medium 6 is vaporised; the metal Me is oxidised at an elevated temperature (Me=Zr is oxidised to ZrO₂; Y is oxidised to Y₂O₃, the nitrate ions react to NO₂).

The reinforcing medium 6 is advantageously an aqueous solution, which contains a salt of the oxidisable metal Me in solution. The oxidised metal is preferably insoluble in water. The metal salt is advantageously a nitrate or an acetate (or a mixture) of the metals Me=Co, Mn, Mg, Ca, Sr, Y, Zr, Al, Ti, Ni, La, Sc and/or of a lanthanide, in particular of one of the lanthanides Ce, Eu, Yb, Nd, Dy or Gd. The reinforcing medium 6 is advantageously a saturated solution, free of solids, the viscosity of which at 20° C. is less than 150 mPa s, preferably less than 35 mPa s. If the reinforcing medium includes a plurality of metals, then the one metal is preferably in solid solution, with the other metal or metals.

It can further be advantageous to add a tenside 6 to the reinforcement means, with which the wetting angle and the surface tension of this liquid with respect to the material of the layer 1 is suitably reduced, so that the largest possible a penetration depth results, also in the fringed edge regions (see FIG. 5).

It can also be advantageous when the reinforcing medium further contains an oxidation medium in order to oxidise the metal or the metals.

The application of the reinforcing medium 6 can take place in a variety of ways, for example by spraying, brushing or immersing or plunging of the layer 1 into a suitable bath. The penetration of the reinforcing medium 6 can advantageously be influenced or assisted by exposure to ultrasound.

In the subsequent introduction of heat the heat feed can be carried out in a thermal oven, in a microwave oven, with a heat radiator, in particular a carbon radiator with a wavelength range of 2 μm-3.5 μm, and/or with a flame, in particular with a flame of a plasma torch.

The introduction of heat can for example be carried out in accordance with a predetermined temperature profile with respect to time. The temperature profile includes intervals, within which the temperature is held, at least approximately, at one level. At the first level, or at the first two levels, which lie in the range of 100° C. to 150° C. for example, a solvent—here water—is vaporised. At the first level the vaporisation takes place at a temperature T, at which no vapour bubbles form. Bubbles of this kind would drive a part of the reinforcing medium 6 out of the capillary spaces 11, 12 again. At a further—higher—level the layer 1 is hardened; for example at a temperature between 250° C. and 400° C. In this connection the metal Me is oxidised at a temperature which is greater than a conversion temperature which is dependent on the oxidisable metal Me.

During this heat treatment the weight of the layer 1 usually reduces as a result of volatile components of the reinforcing medium 6 and the conversion.

For the reinforcement it is generally advantageous to repeat the second step of the method of the invention, namely the application of the reinforcing medium, a plurality of times. In each case a respective application of the reinforcing medium 6 and the heat input to form the oxide of the metal Me takes place.

It has proved particularly favourable, for the greatest possible resistance to erosion of the TBC layer with columnar structure produced by means of LPPS-TF, when the second step, namely the reinforcement, is carried out at least three times, preferably precisely three times.

As a rule the same reinforcement means 6 is always used when repeating the reinforcement step. It is however also possible to provide a different reinforcement means in one or more reinforcements—in particular in a final reinforcement.

Depending on the application it can be advantageous when, after the single or multiple carrying out of the second method step, in other words of the reinforcement, a heat treatment of the layer 1 for sintering additionally takes place. This heat treatment takes place at a higher temperature, for example at 800° C. at least and preferably at a temperature which corresponds to the operating temperature of the layer 1.

In this connection it has been shown that the resistance to erosion of the heat insulating layer 1 initially decreases and then increases again. For this reason this heat treatment is preferably carried out over a time period of several hours, for example approximately ten hours. Depending on the application this heat treatment can take place by the operation of the component, which has the heat insulating layer. If, for example, a turbine blade is provided with the heat insulating layer 1, then the heat treatment for sintering can take place before the start of operation of the turbine or by the operation of the turbine in the first hours after it has started operating.

A heat insulating layer system is shown schematically in FIG. 2, which was generated with the help of a method in accordance with the invention. The layer system is applied to a base body 3—for example a turbine blade—by means of LPPS-thin film-processes. This layer system is composed of a barrier layer 3a, a hot gas corrosion protection layer 4 and a heat insulating layer 1 on a ceramic basis applied in accordance with the invention. A protective layer on an oxide basis—not illustrated—can be additionally provided between the hot gas corrosion protection layer 4 and the heat insulating layer 1.

The base layer comprising the barrier layer 3a and the hot corrosion protection layer 4 has a layer thickness, the magnitude of which is between 50 and 200 μm, preferably 100 μm. A NiAl or NiCr alloy is, for example, deposited on the base body 3 for the barrier layer 3a for example, which can be composed of a Ni or Co based alloy. The hot gas corrosion protection layer 4 is in particular at least partly composed of a metal aluminide or of an MeCrAlY alloy, with Me meaning one of the metals Fe, Co or Ni. The base layer 3a, 4 forms the substrate of the heat insulating layer 1, which is generated and reinforced or impregnated in accordance with the invention and thus has a columnar microstructure. The part layers of the layer system can, if required, all be applied by LPPS-thin film processes in a single working cycle without interruption, or also can be applied in a plurality of consecutive working steps. After the deposition the layer system as a whole can be heat treated.

The method in accordance with the invention can be used to coat components, which are exposed to high process temperatures, with a heat insulating layer system or with a heat insulating layer with columnar structure. Such components are, for example, components of a stationary gas turbine or of an aircraft engine namely, turbine blades, in particular guide vanes or rotor blades or also components which can be subjected to hot gas, for example a heat shield.

In a very simplified illustration, FIG. 3 shows, as an example of use, a segment of a turbine which is designated as a whole with the reference numeral 50. FIG. 4 shows this segment 50 in section, with the section taking place parallel to a base plate designated with the numeral 51 in FIG. 3.

The turbine, for example a steam turbine, a stationary gas turbine or an aircraft engine usually includes a plurality of rotating rotors and stationary guide elements. Both the rotors and the guide elements each include a plurality of turbine blades 52. The turbine blades 52 can each be mounted individually with their foot on a common axis of the turbine or they can be provided in the form of segments, each of which includes a plurality of turbine blades 52. This design is often termed a cluster vane segment or, depending on the number of the turbine blades, a double vane segment, triple vane segment etc.

A segment 50 of a gas turbine of this kind is shown in FIG. 3 and in FIG. 4 in a very simplified illustration, which includes two turbine blades 52, which each extend from the base plate 51 to a cover plate 53. The segment 50 can be made in one piece or comprise a plurality of individual parts. The illustration of details known per se such as, for example, the cooling air bores or passages has been dispensed with in FIGS. 3 and 4 for reasons of a better overall view.

These turbine blades 52 or the segments 50 are often protected with heat insulating layers 100. It is also known that the heat insulating layers contained therein are designed in such a way that they have a columnar structure or microstructure. It has been shown in practice however, that the hitherto known LPPS-TF heat insulating layers with a columnar microstructure only have a comparatively low resistance to erosion and are therefore subject to very severe and rapid wear, particularly in difficult environments such as air containing sand, for example. In this situation the invention provides a solution, because it has been shown, surprisingly, that in heat insulating layers with a columnar structure or microstructure, which are thermally sprayed by means of LPPS-TF, a considerable improvement in the resistance to erosion can be achieved, by a factor 7 for example, through the second method step, namely the reinforcement, through at least partial filling of the capillary spaces.

This is surprising to the extent that one has hitherto assumed that in heat insulating layers with a columnar microstructure, the intermediate spaces between the elongate corpuscles, the columns, should not be filled completely or partly, in order not to endanger the expansion tolerance with respect to the cyclic thermal loading.

A further advantage of the LPPS-TF process is that coating can also be undertaken in shadow regions using this method. In base bodies, such as the segment 50 (FIG. 3 and FIG. 4) for example, geometrical shadow regions or hidden or covered regions exist which can not be reached by the process beam directly—in a geometrical sense—during plasma spraying. It is often the case that such regions can also not be reached by means of a rotation of the base body in the process beam or through another relative movement between the process beam and the base body.

Using the LPPS-TF method a coating can also be manufactured in those regions which are located in the geometrical shadow of the process beam, in other words not in the line of sight of the process beam. It is consequently possible to coat around corners, edges and curves using this method.

This is particularly advantageous for the coating of turbine blades of gas turbines and especially for segments of such turbines which include two or more turbine blades.

Thus it is for example possible, that the turbine blades can not be coated individually but rather in larger clusters.

An additional advantage of the method in accordance with the invention or of the coat produced therewith is that the second step in particular, namely the reinforcement of the layer by means of the filling of the capillary spaces, brings about an improvement of the protection against damage, which is caused by CMAS. The problem of CMAS is known in particular in the turbine industry. CMAS is a compound of calcium, magnesium, aluminium and silicon oxide which melts at relatively low temperatures, which can be incorporated in pores or other capillary spaces and which can cause erosion or the spallation of parts of the layer. Since, in accordance with the invention the capillary spaces are filled, a protection against CMAS results. The formation of CMAS is, in particular, prevented or considerably reduced. Furthermore, a situation can be achieved, by means of the choice of a suitable reinforcing medium 6, in which the reinforcing medium 6 or the oxide formed from this interacts with the melted CMAS, thus forming compounds which only melt at considerably higher temperatures.

1. A method for the manufacture of a functional layer in which, in a first step, a coating material is sprayed onto a surface of a substrate in the form of a jet of powder utilizing a plasma spraying process, wherein the coating material is injected at a low process pressure which is less than 10 000 Pa into a plasma which defocuses the jet of powder and is melted partly or completely there, wherein a plasma with adequately high specific enthalpy is produced, so that a substantial proportion, amounting to at least 5% by weight of the coating material passes over into the vapour phase and an anisotropically structured layer forms on the substrate, wherein elongate corpuscles, which form an anisotropic microstructure, are aligned standing largely perpendicular to the surface of the substrate and transition regions with little material delimit the corpuscles with respect to one another, and in a second step capillary spaces of the layer are filled, with a liquid being used as a reinforcing medium, which includes at least one salt of a metal contained therein, which can be thermally converted into a metal oxide, with the reinforcing medium being applied to the surface of the layer and—after waiting for a penetration into the capillary spaces—an introduction of heat takes place for the formation of an oxide.

2. A method in accordance with claim 1 in which the second step, namely the application of the reinforcing medium and the introduction of heat for the formation of an oxide is carried out at least 2 times.

3. A method in accordance with claim 1 in which the reinforcing medium is an aqueous solution containing a dissolved salt of the oxidizable metal in solution, and the metal salt is at least one of a nitrate or acetate of the metals Co, Mn. Mg, Ca, Sr, Y, Zr, Al, Ti, Ni, La, Sc and a lanthanide.

4. A method in accordance with claim 1, wherein the introduction of heat is carried out in one of a thermal oven, a microwave oven, with a heat radiator, a carbon radiator with a wavelength range of 2 μm-3.5 μm, and with a flame.

5. A method in accordance with claim 1, wherein the introduction of heat is carried out in one of an inert atmosphere and in a vacuum.

6. A method in accordance with claim 1, in which the layer is a thermal insulating layer, and the layer thickness of which has values between 20 μm and 2000 μm.

7. A method in accordance with claim 1, wherein in the plasma spraying process:
wherein a value between 20 and 2000 Pa is selected for the process pressure and the specific enthalpy of the plasma is produced by means of an effective power yield, which lies in the range of 40 to 80 kW;
wherein the jet of powder is injected into the plasma with a feed gas, the process gas is a mixture of at least two inert gases, wherein the volume ratio of the at least two gases is in the range from 2:1 to 1:4, and the total gas flow lies in the range from 30 to 150 SLPM;
wherein the powder feed rate lies between 2 and
wherein during the application of material the substrate is moved with at least one of rotary and pivoting movements relative to a cloud of the defocused jet of powder.

8. A method in accordance with claim 1, in which a material is used for the coating, which contains oxide-ceramic components.

9. A method in accordance with claim 1 in which, after the single or multiple carrying out of the second step, a heat treatment for sintering takes place.

10. A method in accordance with claim 1, in which the substrate is a component of one of a stationary gas turbine, an aircraft engine, a turbine blade, a guide vane, a rotor blade, and a segment, which includes at least two turbine blades or a component which can be subjected to a hot gas, and a heat shield.

11. A component with a functional layer characterised in that the layer is generated using a method in accordance with claim 1.

12. The method of claim 1, wherein the introduction of heat for the formation of an oxide is carried out three times.

13. The method of claim 3, wherein the lanthanide is one of Ce, Eu, Yb, Nd, Dy and Gd.

14. The method of claim 1, wherein the anisotropically structured layer has a layer thickness between 100 μm and 500 μm.

15. The method of claim 1, wherein the process pressure is between 100 and 500 Pa.

16. The method of claim 7, wherein the at least two inert gases are argon and helium.

17. The method of claim 7, wherein the inert gas mixture further comprises at least one of hydrogen and nitrogen.

18. The method of claim 7, wherein the powder feed rate is between 10 and 40 g/min.

19. The method of claim 8, wherein the component is a zirconium oxide stabilised with at least one of magnesium, calcium, scandium, yttrium, cerium, dysprosium, and other rare earths, and the material used as a stabiliser is added to the zirconium oxide in the form of an oxide of the rare earths or of the said magnesium or of the said calcium.

20. The method of claim 9, wherein the heat treatment for sintering is performed at a temperature of at least 800° C.
